(19) United States
(12) Patent Application Publication
(10) Pub. No.: US 2013/0038897 A1
(43) Pub. Date: Feb. 14, 2013

(54) PRINTING DEVICE DISCOVERY

(71) Applicants: Claudio Andre Heckler, Novo Hamburgo (BR); Mairo Pedrini, Porto Alegre (BR); Juliano Demarchi Acauan, Porto Alegre (BR)

(72) Inventors: Claudio Andre Heckler, Novo Hamburgo (BR); Mairo Pedrini, Porto Alegre (BR); Juliano Demarchi Acauan, Porto Alegre (BR)

(21) Appl. No.: 13/205,333

(22) Filed: Aug. 8, 2011

(51) Int. Cl. G06F 3/12

(52) U.S. Cl. 358/1.15

(57) ABSTRACT

A method for printing device discovery includes, with a server system on a network, sending out a broadcast request to determine network addresses for printing devices on the network, interrogating the printing devices to determine characteristics of the printing devices, categorizing the printing devices based on the characteristics, and providing a list of classified printing devices to a client device on the network in response to a request from the client device.

### BACKGROUND

Several computing systems within an office environment are often configured to print to one of many printing devices available within that office environment. The computing systems are able to connect to the printing devices through a computer network. With the appropriate printing driver for each of those printing devices on the network, the computing system can print files to those printing devices. In some cases, a universal print driver can be used to allow a client device to print to different types of printing devices that are compatible with that universal print driver. This eliminates the use of a different print driver for each of the printing devices on a network.

Although a user may have a default printing device, he or she may roam throughout the office environment with a mobile computing device such as a laptop computer. When that user wishes to print a document, he or she would prefer to print to a nearby printing device. To do so, the user initiates a discovery process to determine what nearby printing devices are available on the network. The user can then search through those printing devices to find one that is both located close to the user and provides the printing capabilities that the user desires for a particular print job. For example, if the user wishes to print a color document, he or she has to find a printing device that is capable of color printing. This discovery process can be time consuming. Often times, users do not wish to wait for this process to complete before selecting a printing device.

### BRIEF DESCRIPTION OF THE DRAWINGS

The accompanying drawings illustrate various examples of the principles described herein and are a part of the specification. The drawings are merely examples and do not limit the scope of the claims.

FIG. 1 is a diagram showing an illustrative client server system, according to one example of principles described herein.

FIG. 2A is a diagram showing an illustrative network system, according to one example of principles described herein.

FIG. 2B is a diagram showing an illustrative network system with a centralized printing device discovery application, according to one example of principles described herein.

FIG. 3A is a flowchart showing an illustrative full discovery process, according to one example of principles described herein.

FIG. 3B is a flowchart showing an illustrative quick discovery process, according to one example of principles described herein.

FIG. 4 is a diagram showing an illustrative user interface of a client device, according to one example of principles described herein.

FIG. 5 is a flowchart showing an illustrative method for centralized printing device discovery, according to one example of principles described herein.

Throughout the drawings, identical reference numbers designate similar, but not necessarily identical, elements.

### DETAILED DESCRIPTION

As mentioned above, when a user wishes to print a document, he or she would prefer to print to a nearby printing device. To do so, the user initiates a discovery process to determine what nearby printing devices are available on the network. The user can then search through those printing devices to find one that is both located close to the user and provides the printing capabilities that the user desires for a particular print job. For example, if the user wishes to print a color document, he or she has to find a printing device that is capable of color printing. This discovery process can be time consuming. Often times, users do not wish to wait for this process to complete before selecting a printing device.

In light of this and other issues, the present specification discloses methods and systems for centralized printing device discovery. According to certain illustrative examples, a printing device discovery application runs on a network server. This server queries the network to determine the location and capabilities of all available printing devices on the network. The server also updates this information periodically. When a client device runs a search for printing devices available on the network, a request is sent to the server. The server then responds by sending the list of available printing devices to the client device. Thus, the client device can near instantaneously obtain the list of available printing devices because the list is maintained by the server device and is kept current through periodic update discovery processes.

Through use of methods and systems embodying principles described herein, a user will be able to readily obtain a list of printing devices on his or her network. The user will not have to wait for the discovery process to be made before being presented with the list of available printing devices. This list may be categorized so as to provide the user with a simple mechanism for selecting the desired type of printing device. For example, the list of printing devices may be categorized based on characteristics of those printing devices such as location or capabilities.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

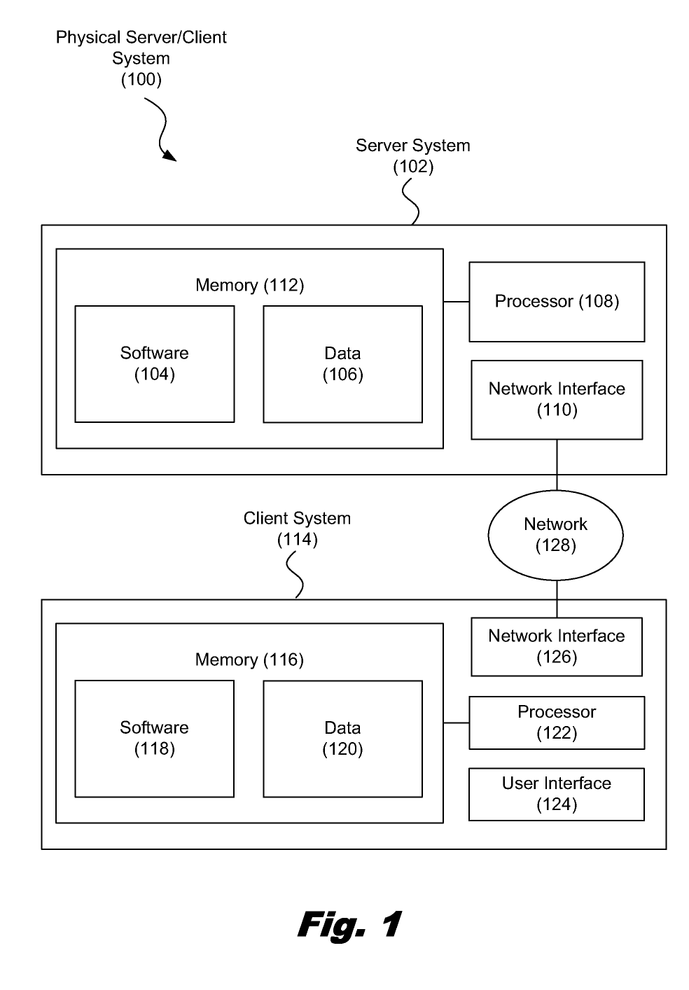

Referring now to the figures, FIG. 1 is a diagram showing an illustrative physical server client system (100). According to certain illustrative examples, the server system (102) includes a memory (112) having software (104) and data (106) stored thereon. The physical computing system (100) also includes a processor (108) and a network interface (110).

There are many types of memory available. Some types of memory, such as solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The physical computing system (100) also includes a processor (108) for executing the software (104) and using or updating the data (106) stored in memory (102). The software (104) may include an operating system. An operating system allows other applications to interact properly with the hardware of the server system (102). One type of application may be a printing device discovery application. The data (106) stored within memory may be data that includes a list of available printing devices as well as characteristics of those printing devices.

The network interface (110) includes the hardware and software for interfacing with a network (128). Through the network, the server system can communicate with client systems (114). According to certain illustrative examples, a client system (114) includes a memory (116) having software (118) and data (120) stored thereon. The client system (114) also includes a processor (122), a network interface (126), and a user interface (124).

The software (118) may include an operating system. The operating system of the client system (114) allows various applications to interact properly with the hardware of the client system (114). Various applications will display data that can be sent to a printing device to be printed. The software may also include device drivers that allow the client device to interact with the hardware of a printing device and thus print documents to that device.

A user interface (124) may provide a means for a user to interact with the client system (114). The user interface (124) may include any collection of devices for interfacing with a human user. For example, the user interface (124) may include an input device such as a keyboard or touchscreen and an output device such as a monitor.

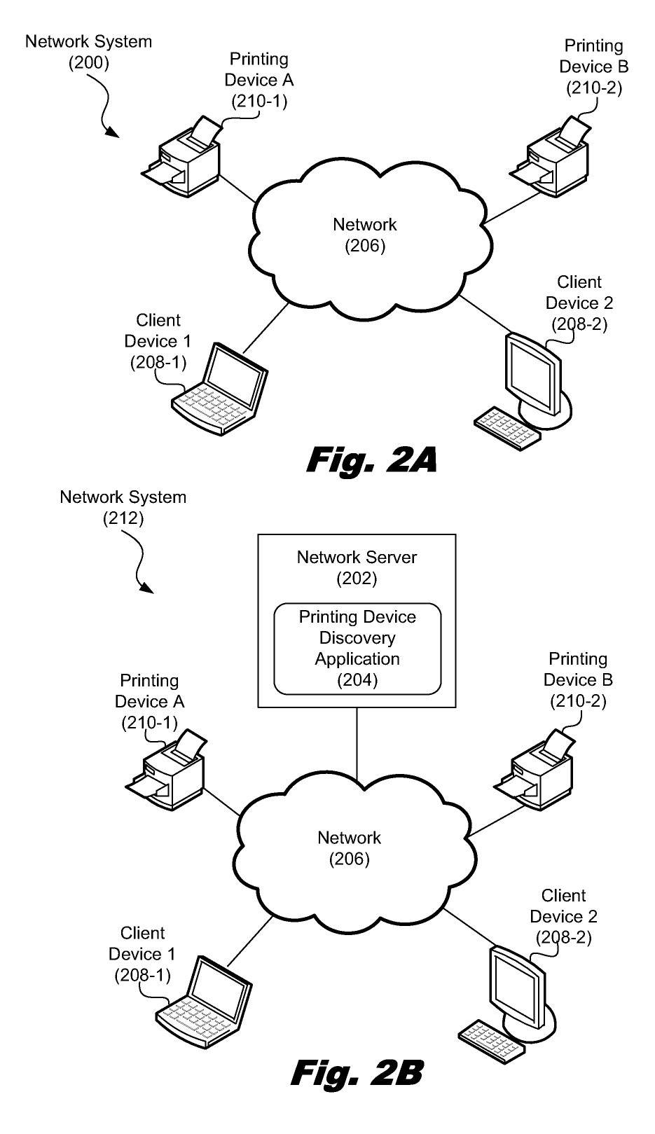

FIG. 2A is a diagram showing an illustrative network system (200). According to certain illustrative examples, client devices (208) connected to the network (208) may print documents to printing devices (210) that are also connected to the network (208).

In one example, a user of a client device may typically use a particular network printing device based on his or her proximity to that particular network printing device. For example, client device 1 (208-1) may be nearby printing device A (210-1). Thus the printing device settings for client device 1 (208-1) may have printing device A (210-1) as the default printing device. However, it may be the case that client device 1 (208-1) roams to a different location within the office environment. At this new location, printing device B (210-2) may be the closest printing device. The user will then have to run a search for nearby printing devices. When the user does this, a network discovery process occurs.

In a further example, client device 2 (208-2) may typically use a printing device B (210-2) which is a black and white only printing device. Thus the printing device settings for client device 2 (208-2) may have printing device b (210-2) as the default printing device. However, it may be the case that client device 2 (208-2) wishes to print a color picture. The client device (208-3) will then have to determine the available printing devices on the network that are capable of color printing. This is determined through the network discovery process.

To perform the network discovery process, the client device (208) will send out broadcast messages over the network. The client device (208) will then wait for any responses to those broadcasts and formulate a list based on the received responses. This can take anywhere from 10-15 seconds. Users may get frustrated when having to wait this long for the discovery process to occur.

In light of this issue, the present specification discloses a method of centralized printing device discovery. FIG. 2B is a diagram showing an illustrative network system (212) with a centralized printing device discovery application (204). According to certain illustrative examples, a printing device discovery application (204) that runs on a network server (202) performs this discovery process. A full discovery process that determines which printing devices are on the network and discovers characteristics of those printing devices such as location, capabilities, and status is performed periodically. For example, this full discovery process may run every 6 hours.

Within these six hour periods, a quick discovery process may be executed more frequently. For example, the quick discovery process may run every 10 minutes. The quick discovery process may simply determine if the printing devices within the list of printing devices on the network are still there. The quick discovery process may also determine if any new printing devices have been connected to the network (206). The quick discovery process may also determine if there have been any changes in the status of any of the printing devices. For example, it may be that one of the printing devices is out of paper or out of toner.

With the list of available printing devices being regularly updated and maintained by a network server (202), the list is readily available to client devices that are requesting the list. Thus, when a user wishes to view the list of available printing devices on the network, the client device will request that list from the server rather than run the discovery process itself. The following will describe the full discovery process and the quick discovery process in more detail.

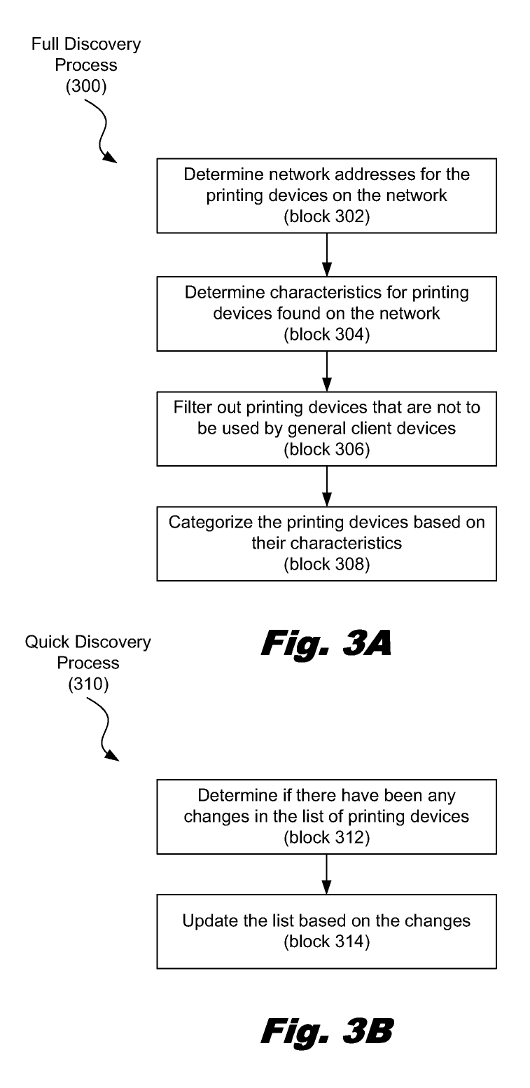

FIG. 3A is a flowchart showing an illustrative full discovery process (300). According to certain illustrative examples, the full network discovery process (300) begins by determining (block 302) the network address for each printing device on a network. This can be done by sending out a broadcast query message over the network using a protocol such as Simple Network Management Protocol (SNMP). SNMP is a protocol that is commonly used to manage devices on a network. In response to receiving an SNMP broadcast query, a printing device will send a message back to the server that includes the network address for that printing device.

With the list of network addresses for the printing devices on the network, the printing device discovery application can begin an interrogation process that involves determining (block 304) the characteristics for the printing devices on the network. These characteristics may include location information, assigned printing device names, printing capabilities such as color capability, and printing device status. This information may also be obtained using SNMP protocol. However, other protocols may be used as well.

A variety of mechanisms can be used to determine the location of a printing device. For example, a network administrator may assign names to printing devices that indicate its location. For example, the name of the printing device may include the room number where the printing device is located. Alternatively, a network server may maintain a table that correlates printing device names to locations of those printing devices. When a printing device is moved, the network administrator can update that table accordingly. By knowing the location of the printing devices, the printing device discovery application can determine which printing devices are near a particular client device if the location of that client device is also known. Various methods for determining the location of a client device which may be used are beyond the scope of the present application. Thus, description of such methods will not be provided.

Various printing devices include a wide variety of functionality. For example, some printing devices print only black and white documents while other printing devices can print color images. Furthermore, some printing devices may be designed to print on particular types of media such as different types of paper. Some printing devices may be designed for printing large documents and thus print at a much faster rate than a printing device designed more for quality rather than speed. Such capabilities may be important to a user who wishes to print a particular document. Thus, the printing device discovery application can determine these capabilities. These capabilities may be indicated by the software embedded in a printing device itself. For example, a printing device may include a Read Only Memory (ROM). This ROM can be configured to provide its capabilities to the printing device discovery application.

In some cases, there will be printing devices on the network that are only to be used by a particular client device. Thus, these printing devices will not be available to the general client devices. The printing device discovery application can filter (block 306) the list of printing devices and remove any devices that should not be available to general client devices on the network. Various criteria for removing a particular printing device from the list of available printing devices to be displayed to users may also be used.

With the list of available printing devices and the characteristics of those printing devices, the printing device discovery application can categorize (block 308) each of the printing devices according to the characteristics of those printing devices. For example, the printing devices may be classified by location. The printing devices may be categorized based on the floor where they are located. The printing devices may be further categorized based on the section of the floor where they are located. Printing devices may also be categorized based on their capabilities. For example, there may be a black and white category as well as a color printing device category. There may also be categories based on which size of paper a printing device is capable of handling or with which type of paper the printing device is currently stocked. A particular printing device may belong to more than one category.

FIG. 3B is a flowchart showing an illustrative quick discovery process (310). The quick discovery process (310) may be performed on a periodic schedule that is much more frequent than the periodic scheduled of the full discovery process. For example, while the full discovery process may be performed every few hours, the quick discovery process may be performed every few minutes.

According to certain illustrative examples, the quick discovery process begins by determining (block 312) if there have been any changes to any of the printing devices. For example, the printing device discovery application may determine whether any printing devices have been disconnected from the network. Furthermore, the printing device discovery application may determine whether any new printing devices have been added to the network.

During the course of operation, the status of printing devices will change. For example, printing devices occasionally run out of paper, toner, or ink. Thus, they will temporarily be offline until the paper, toner, or ink is replaced. The printing device discovery application can determine whether the status of any of the printing devices has changed.

If it is determined that there have been changes to any of the printing devices on the network, then the printing device discovery application can update (block 314) the list of available printing devices accordingly. For example, if it is determined that a particular printing device has been removed from the network, then the printing device discovery application can remove that printing device from the list of available printing devices. If it is determined that a new printing device has been added to the network, then the printing device discovery application can determine the characteristics of that device and categorize that printing device appropriately. If any changes in status have been discovered then the characteristics of the printing devices can be changed accordingly. This may result in a change of categorization for some printing devices.

By performing a full discovery on a longer periodic schedule and a quick discovery on a shorter periodic schedule, network traffic is reduced while the list of available printing devices is kept current. With this list of available printing devices stored on the server, it will be readily available to a client device so that client device will not have to perform the discovery process itself. When a client device desires to search for network printing devices, the client device will request the updated list from the server. This process is near instantaneous as it is just a quick transfer of a relatively small amount of data.

With the list of available printing devices being categorized, a user can readily view the printing devices that may be relevant based on his or her indications. For example, if a user wishes to find a printing device near his or her current location, then that user can be displayed the printing devices that have been categorized for that particular location. Specifically, if a user is located in a specific region on a specific floor within the office environment, then the user may be provided a list of only the available printing devices within that region. Through a user interface on a client device, a user may be able to select other capabilities in which he or she is interested.

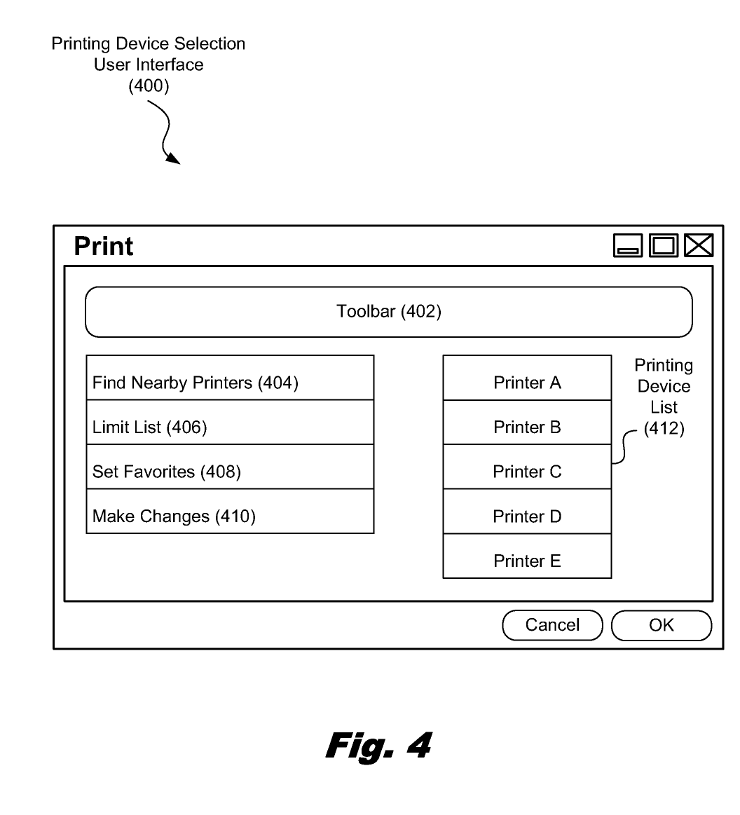

FIG. 4 is a diagram showing an illustrative printing device selection user interface (400) of a client device. The printing device selection user interface (400) may be embodied as a window that appears when a user attempts to print a document. According to certain illustrative examples, the user interface includes a “Find Nearby Printers” control (404), a “Limit List” control (406), a “Set Favorites” control (408), a “Make Changes” control (410) and a printing device list (412). The user interface (400) also includes a toolbar (402) to provide a user with various tools and options relating to the print selection user interface (400).

The “Find Nearby Printers” control (402) provides the user with a mechanism for obtaining a list of available printing devices nearby. As mentioned above, because the discovery process is performed by the server, the client device will not perform this process. When the user selects “Find Nearby Printers”, the client device running the user interface will request the list of available printing devices from the server. Because the server has already categorized the list of available printing devices by location, the server can send the list of printing devices within the category associated with the user's location. Upon receiving a response from the server, the user interface will display the printing device list (412) to the user.

In some cases, the user may wish to limit the list based on a variety of criteria. For example, the user may wish to see only a list of color printing devices. Alternatively, the user may only wish to see printing devices that print on paper of a particular size. The user can use the “Limit List” control (406) to select these criteria. The printing device list (412) can then be refined accordingly.

In some cases, a user may have one or more favorite printing devices with which he or she regularly prints documents. The user can use the “Set Favorites” setting to indicate these printing devices. The favorite printing devices may then be displayed differently in the printing device list. Thus, the user can readily identify which printing devices that he or she prefers.

In some cases, the user may notify that there are errors in the printing list. For example, a user may notice that the name of a printing device is misspelled or has a typo. Alternatively, the user may notice that a certain printing device is said to have a certain capability which it actually does not. In some cases, the user may notice that a particular printing device is not located where it purports to be located. In such cases, the user can make changes to the characteristics of that printing device through use of the “Make Changes” control (410). When a user makes a change, the client device running the user interface (400) can send a suggestion back to the server that something should be changed. The change may be implemented automatically or it may wait for approval from a network administrator.

The above described user interface is for illustrative purposes only. It is not necessarily representative of a user interface that may be used for a client side device that utilizes principles described herein. Any type of user interface that comports with principles described herein may be used.

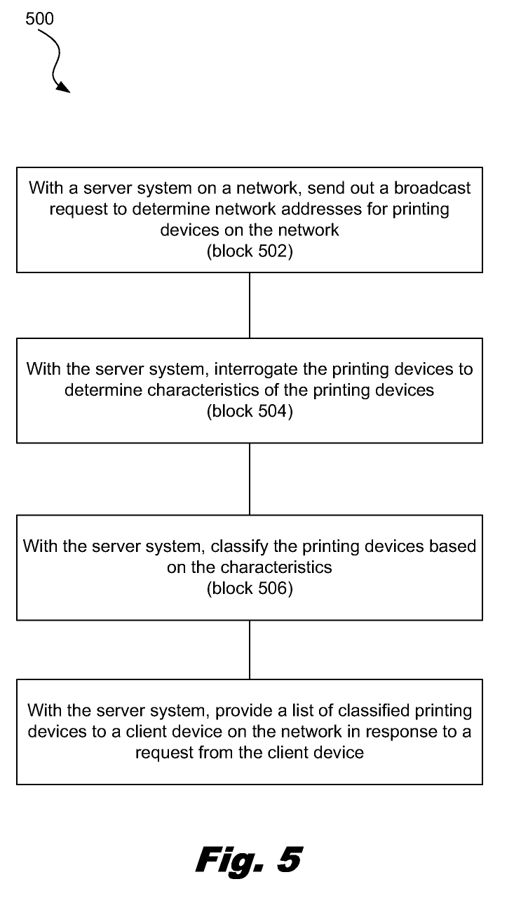

FIG. 5 is a flowchart showing an illustrative method for centralized printing device discovery includes, with a server system on a network, sending (block 502) out a broadcast request to determine network addresses for printing devices on the network, with the server system, interrogating (block 504) the printing devices to determine characteristics of the printing devices, with the server system, categorizing (block 506) the printing devices based on the characteristics, and with the server system, providing (block 508) a list of classified printing devices to a client device on the network in response to a request from the client device.

In conclusion, through use of methods and systems embodying principles described herein, a user will be able to readily obtain a list of printing devices on his or her network. The user will not have to wait for the discovery process to be made before being presented with the list of available printing devices. This list may be categorized so as to provide the user with a simple mechanism for selecting the desired type of printing device. For example, the list of printing devices may be categorized based on characteristics of those printing devices such as location or capabilities.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for printing device discovery, the method comprising:
with a server system on a network, sending out a broadcast request to determine network addresses for printing devices on said network;
with said server system, interrogating said printing devices to determine characteristics of said printing devices;
with said server system, categorizing said printing devices based on said characteristics; and
with said server system, providing a list of classified printing devices to a client device on said network in response to a request from said client device.

2. The method of claim 1, further comprising, periodically performing a quick discovery process that comprises determining if there have been any changes in the characteristics of said printing devices.

3. The method of claim 2, further comprising, updating said classified list in response to discovering said changes.

4. The method of claim 1, wherein said characteristics of one of said printing devices comprises at least one of: a location of said printing device, a capability of said printing device and a status of said printing device.

5. The method of claim 1, further comprising, with said client device, displaying said classified list to a user in response to a user attempting to print a file from said client device.

6. The method of claim 5, wherein said list is displayed to said user according to personalization settings for said user.

7. The method of claim 1, further comprising, filtering said list based on predefined criteria relating to usability of said printing devices.

8. The method of claim 1, further comprising, with said server system, receiving data from a client device suggesting a change to a characteristic of one of said printing devices.

9. A server system comprising:
at least one processor;
a memory communicatively coupled to the at least one processor, the memory comprising computer executable code that, when executed by the at least one processor, causes the at least one processor to:
send out a broadcast request to determine network addresses for printing devices on said network;
interrogate said printing devices to determine characteristics of said printing devices;
categorize said printing devices based on said characteristics; and
provide a list of classified printing devices to a client device on said network in response to a request from said client device.

10. The system of claim 9, wherein said computer executable code further causes said processor to periodically perform a quick discovery process that comprises determining if there have been any changes in the characteristics of said printing devices.

11. The system of claim 10, wherein said computer executable code further causes said processor to update said classified list in response to discovering said changes.

12. The system of claim 9, wherein said characteristics of one of said printing devices comprises at least one of: a location of said printing device, a capability of said printing device and a status of said printing device.

13. The system of claim 9, wherein said computer executable code further causes said processor to filter said list based on predefined criteria relating to usability of said printing devices.

14. The system of claim 9, wherein said computer executable code further causes said processor to receive data from a client device suggesting a change to a characteristic of one of said printing devices.

15. A method for printing device discovery, the method comprising:
with a server system and on a first periodic schedule:
sending out a broadcast request to determine network addresses for printing devices on said network;
interrogating said printing devices to determine characteristics of said printing devices;
categorizing said printing devices based on said characteristics; and
providing a list of classified printing devices to a client device on said network in response to a request from said client device; and
with said server system and on a second periodic schedule that is more frequent than said first periodic schedule:
querying said network to determine if there have been any changes in said characteristics of said printing devices; and
updating said list in response to discovering said changes.
